(19) United States
(12) Patent Application Publication
(10) Pub. No.: US 2011/0235753 A1
(43) Pub. Date: Sep. 29, 2011

(54) WIRELESS COMMUNICATION DEVICE AND WIRELESS COMMUNICATION METHOD

(75) Inventor: Koji Horisaki, Yokohama-shi (JP)

(73) Assignee: KABUSHIKI KAISHA TOSHIBA, Tokyo (JP)

(21) Appl. No.: 12/883,716

(22) Filed: Sep. 16, 2010

(30) Foreign Application Priority Data
Mar. 23, 2010 (JP) 2010-066941

(51) Int. Cl. H04L 27/06; H04L 27/08

(52) U.S. Cl. 375/340; 375/344

(57) ABSTRACT

According to one embodiment, a wireless communication device includes a receiver, a physical layer processor, a MAC layer controller, and a channel setting unit. The receiver receives wireless signals received by using a plurality of communication channels as a baseband signal. The physical layer processor processes a physical layer of the baseband signal. The MAC layer controller recognizes a first frequency band used by a first communication channel, and determines whether a second frequency band is adjacent to the first frequency band or not. The channel setting unit supplies the first frequency band to the receiver, and controls the physical layer processor depending on information as to whether the first frequency band is adjacent to the second frequency band or not.

### CROSS-REFERENCE TO RELATED APPLICATIONS

This application is based upon and claims the benefit of priority from Japanese Patent Application No. 2010-066941, filed Mar. 23, 2010; the entire contents of which are incorporated herein by reference.

### FIELD

Embodiments described herein relate generally to, for example, a wireless communication device.

### BACKGROUND

In a wireless communication device using IEEE (Institute of Electrical and Electronics Engineers) 802.11 standard, a technique of suppressing interference from an adjacent channel is proposed.

For example, Jpn. Pat. Appln. KOKAI Publication Nos. 2008-228091 and 11-196043 disclose a method of controlling the transfer speed of a base station side that transmits a wireless signal in accordance with a use state of an adjacent channel, and a method of controlling transmission power from a transmission side so as to reduce interference from an adjacent channel. However, in these techniques, there is the tendency that the burden is on the transmission side.

On the other hand, as a technique on the side of a terminal station that receives a wireless signal, a method of detecting an adjacent channel to control the width of the passband of a filter is disclosed in Jpn. Pat. Appln. KOKAI Publication No. 2006-121146. In this case, however, there is a tendency that the chip area on the reception side increases, and the cost is high.

### BRIEF DESCRIPTION OF THE DRAWINGS

FIG. 1 is a conceptual diagram of a wireless communication system according to a first embodiment;

FIG. 2 illustrates a communication channel used by the wireless communication system according to the first embodiment;

FIGS. 3A and 3B are band diagrams showing frequency bands used by the wireless communication system according to the first embodiment, wherein FIG. 3A is a band diagram in which first to third frequency bands are adjacent to each another, and FIG. 3B is a band diagram in which the first to third frequency bands are apart from each other;

FIG. 4 is a block diagram showing a wireless LAN terminal station according to the first embodiment;

FIG. 5 is a block diagram showing the details of the wireless LAN terminal station according to the first embodiment;

FIG. 6 is a conceptual diagram of received signals detected by a detector according to the first embodiment;

FIG. 7 is a flowchart showing operations of a wireless LAN terminal according to the first embodiment;

FIG. 8 is a block diagram showing the details of a wireless LAN terminal station according to a second embodiment;

FIGS. 9A and 9B are conceptual diagrams of an analog filter and a digital filter according to the second embodiment, wherein FIG. 9A is a conceptual diagram of an analog filter and a digital filter each having a wide bandwidth, and FIG. 9B is a conceptual diagram of an analog filter and a digital filter each having a narrow bandwidth;

FIG. 10 is a flowchart showing operations of a wireless LAN terminal station according to the second embodiment;

FIG. 11 is a block diagram showing the details of a wireless LAN terminal station according to a third embodiment;

FIG. 12 is a flowchart showing operations of a wireless LAN terminal according to the third embodiment;

FIG. 13 is a block diagram showing the details of a wireless LAN terminal station according to a fourth embodiment;

FIGS. 14A and 14B are conceptual diagrams showing input levels of signals received by an RF unit according to the fourth embodiment;

FIG. 15 is a flowchart showing operations of a wireless LAN terminal according to the fourth embodiment; and

FIGS. 16A and 16B are conceptual diagrams showing input levels of signals received by the RF unit according to the fourth embodiment.

### DETAILED DESCRIPTION

First to fourth embodiments will be described below with reference to the drawings. In the description, common reference numerals denote common parts in the diagrams.

In general, according to one embodiment, a wireless communication device includes a receiver, a physical layer processor, a MAC layer controller, and a channel setting unit. The receiver receives wireless signals received by using a plurality of communication channels as a baseband signal. The physical layer processor processes a physical layer of the baseband signal received by the receiver. The MAC layer controller recognizes a first frequency band used by a first communication channel in the communication channels, based on the baseband signal supplied from the physical layer processor. The MAC layer controller determines whether a second frequency band used by a second communication channel different from the first communication channel in the communication channels is adjacent to the first frequency band or not. The channel setting unit supplies the first frequency band supplied from the MAC layer controller and used by the first communication channel to the receiver. The channel setting unit controls the physical layer processor depending on information as to whether the first frequency band supplied from the MAC layer controller is adjacent to the second frequency band or not.

### First Embodiment

A wireless communication device and a wireless communication method according to a first embodiment will be described with reference to FIG. 1. FIG. 1 is a conceptual diagram of a wireless communication system according to the embodiment. In a wireless LAN system according to the embodiment, wireless communication according to the IEEE 802.11ac standard is performed. In the embodiment, particularly, when a signal received by a wireless LAN terminal station has signal intensity exceeding a predetermined threshold level, it is determined that the possibility that the signal is a wireless LAN signal is high, and the signal is demodulated and decoded. Hereinbelow, the wireless LAN system according to the embodiment will be described.

As illustrated in the diagram, the wireless LAN system according to the embodiment includes a wireless LAN base station 100, a wireless LAN terminal station 200, and a wireless LAN terminal station 300 among which wireless communication is performed. A unit constructed by the wireless base station 100 and at least one wireless terminal station 200 is called a basic service set (BSS) in the IEEE 802.11 standard. Although the number of wireless terminal stations included in the BSS is two in FIG. 1, the number of wireless terminal stations is not particularly limited. In the following, it is assumed that in the wireless communication system according to the embodiment, particularly, each of the wireless LAN base station 100 and the wireless LAN terminal station 200 includes three antennas, and the stations 100 and 200 perform wireless communication with each other via the three antennas. With this configuration, high-speed communication is realized.

However, as long as desired performance is obtained, the number of antennas mounted on the wireless LAN base station 100 and the wireless LAN terminal stations 200 and 300 may be one, and the number is not limited.

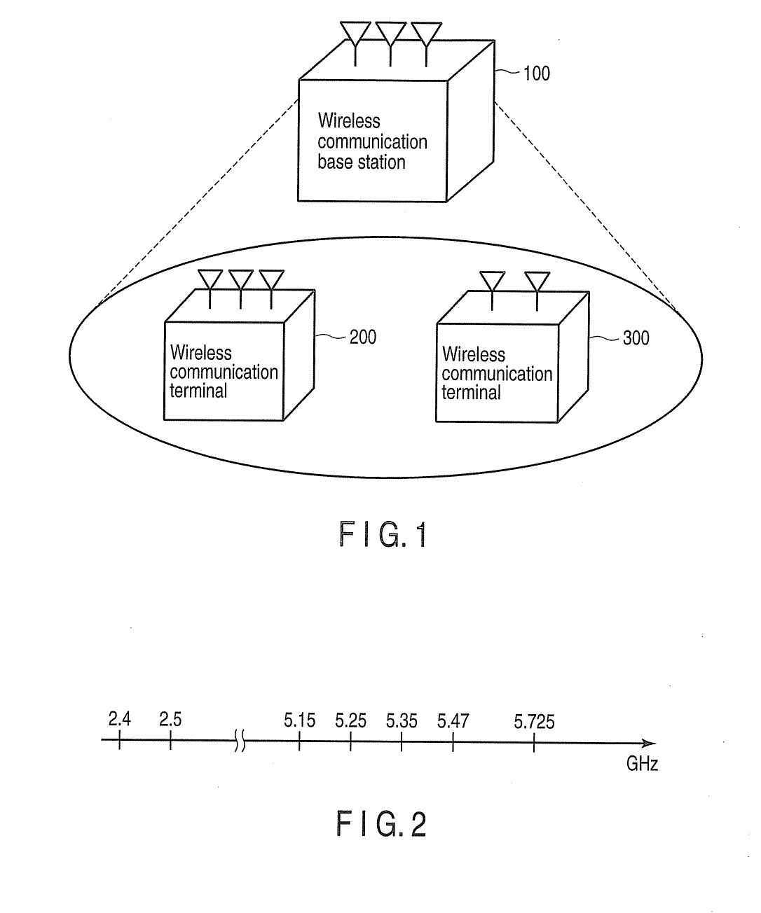

FIG. 2 is a conceptual diagram showing frequency bands used in the wireless LAN system according to the embodiment. In the wireless communication system in the embodiment, frequency bands equal to or below 6 GHz band are used. The frequency bands used are, for example, the band from 2.4 GHz to 2.5 GHz, the band from 5.15 GHz to 5.25 GHz, the band from 5.25 GHz to 5.35 GHz and, further, the band from 5.47 GHz to 5.725 GHz. The wireless LAN base station 100, and the wireless LAN terminal stations 200 and 300 according to the embodiment are set, for example, in a 20 to 40 [MHz] bandwidth in the frequency bands as a frequency channel for one antenna and perform wireless communication using one antenna per frequency channel. That is, since each of the wireless LAN base station 100 and the wireless LAN terminal station 200 according to the embodiment uses, for example, three antennas, wireless communication is performed using the 60 to 120 [MHz] bandwidth. Although an aspect of combining an MIMO (Multi Input Multi Output) technique using a plurality of antennas per frequency channel may be also implemented, the description will not be given here. In the following description, it is assumed that a 40 [MHz] bandwidth is used per antenna in the embodiment.

<Communication Channel>

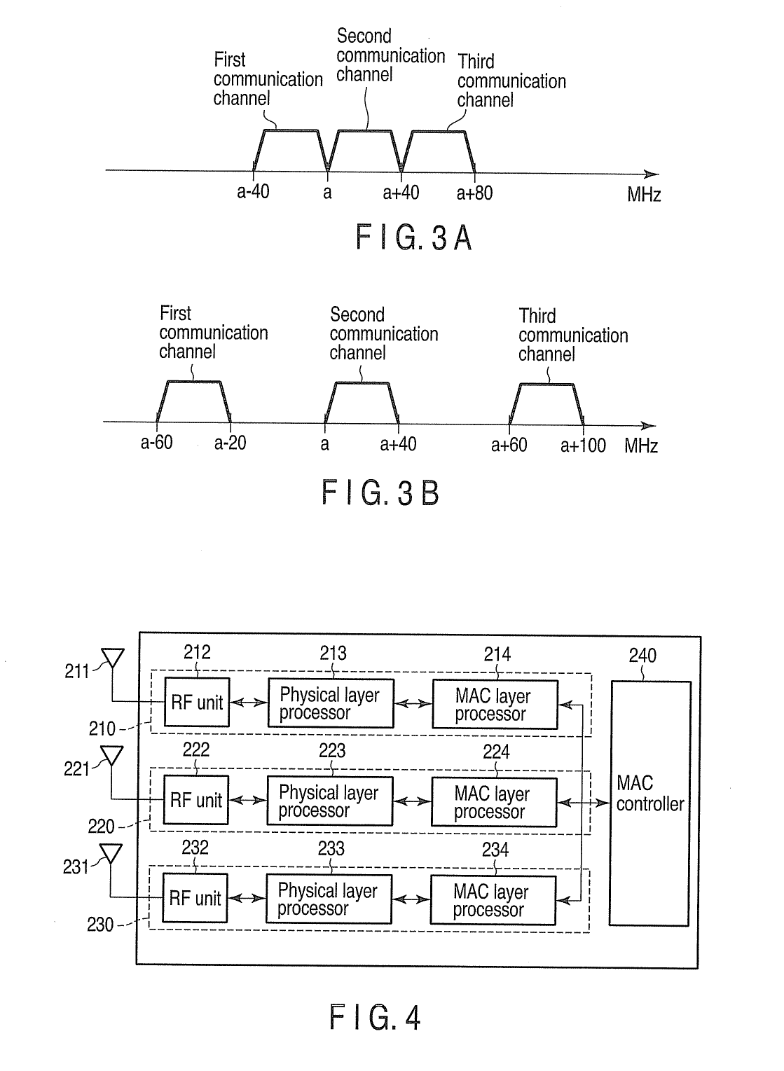

FIGS. 3A and 3B are band diagrams showing frequency bands used in the wireless communication system according to the embodiment. FIG. 3A is a band diagram when the wireless LAN base station 100 and, for example, the wireless LAN terminal station 200 perform transmission/reception of a wireless signal using neighboring frequency bands in a BSS according to the embodiment.

FIG. 3B is a band diagram when the wireless LAN base station 100 and, for example, the wireless LAN terminal station 200 perform transmission/reception of a wireless signal using frequency bands apart from each other.

As shown in FIGS. 3A and 3B, the wireless communication system according to the embodiment uses a first frequency band as a first communication channel, a second frequency band as a second communication channel, and a third frequency band as a third communication channel.

As shown in FIG. 3A, the first to third communication channels have, for example, a bandwidth of 120 MHz from (a−40) to (a+80) [MHz] in the available frequency bands illustrated in FIG. 2. For example, in the frequency band used in the wireless communication system shown in FIG. 1, when the value “a” is 5,240 [MHz], the value (a+40) is 5,280 [MHz], the value (a+80) is 5,320 [MHz], and the value (a−40) is 5,200 [MHz]. As shown in FIG. 3B, the first to third communication channels have, for example, a bandwidth of 120 MHz from (a−60) to (a−20), from “a” to (a+40) and, further, from (a+60) to (a+100) [MHz] in the available frequency bands illustrated in FIG. 2.

<Configuration of Wireless LAN Terminal Station 200>

Next, the configuration of the wireless LAN terminal stations 200 and 300 described in FIG. 1 will be described with reference to FIG. 4. Since the wireless LAN terminal stations 200 and 300 have similar configurations in the embodiment, the case of the wireless LAN terminal station 200 will be described below as an example. FIG. 4 is a block diagram showing the wireless LAN terminal station 200.

As described above, the wireless LAN terminal station 200 includes three antennas. Specifically, the wireless LAN terminal station 200 has a plurality of (three) configurations each made by an antenna and a communication module corresponding to the antenna. Further, the wireless LAN terminal station 200 includes a MAC controller 240 controlling the plurality of communication modules and antennas. The communication module includes an RF (Radio Frequency) unit, a physical layer processor, and a MAC layer processor.

The wireless LAN terminal station 200 includes antennas 211, 221, and 231, communication modules 210, 220, and 230 corresponding to the antennas 211, 221, and 231, respectively, and a MAC controller 240. Each of the communication modules 210, 220, and 230 may be formed by a single chip, or the communication modules 210, 220, and 230 may be together formed into a single chip.

The antenna 211 performs wireless communication using the first communication channel, the antenna 221 performs wireless communication using the second communication channel and, further, the antenna 231 performs wireless communication using the third communication channel.

When the first to third communication channels are adjacent as shown in FIG. 3A, for an antenna to which attention is paid, the other communication channels are regarded as interference signals.

Next, the communication modules 210, 220, and 230 will be described. The communication module 210 includes an RF unit 212, a physical layer processor 213, and a MAC layer processor 214. Similarly, the communication module 220 includes an RF unit 222, a physical layer processor 223, and a MAC layer processor 224. The communication module 230 includes an RF unit 232, a physical layer processor 233, and a MAC layer processor 234. In the wireless LAN terminal station 200 to be described below, the communication modules 210, 220, and 230 have the same configuration except for the reference numerals, and the antennas 211, 221, and 231 have the same configuration except for the reference numerals. Consequently, description will be given by paying attention to the antenna 211 and the communication module 210 corresponding to the antenna 211.

<Details of Wireless LAN Terminal Station 200>

The antenna 211 receives a wireless signal (RF signal: analog signal) transmitted from the wireless LAN base station 100 in the BSS and transmits a wireless signal toward the wireless LAN base station 100.

At the time of receiving a wireless signal, the RF unit 212 down-converts a wireless signal (analog signal) in, for example, the 5 GHz band received by the antenna 211 and supplies the resultant signal to the physical layer processor 213. That is, by performing the down-conversion, a baseband signal of the received signal is obtained. At the time of transmitting a wireless signal, the RF unit 212 up-converts an analog signal (baseband signal) given from the physical layer processor 213 to a wireless signal in the 5 GHz band and supplies the resultant signal from the antenna 211.

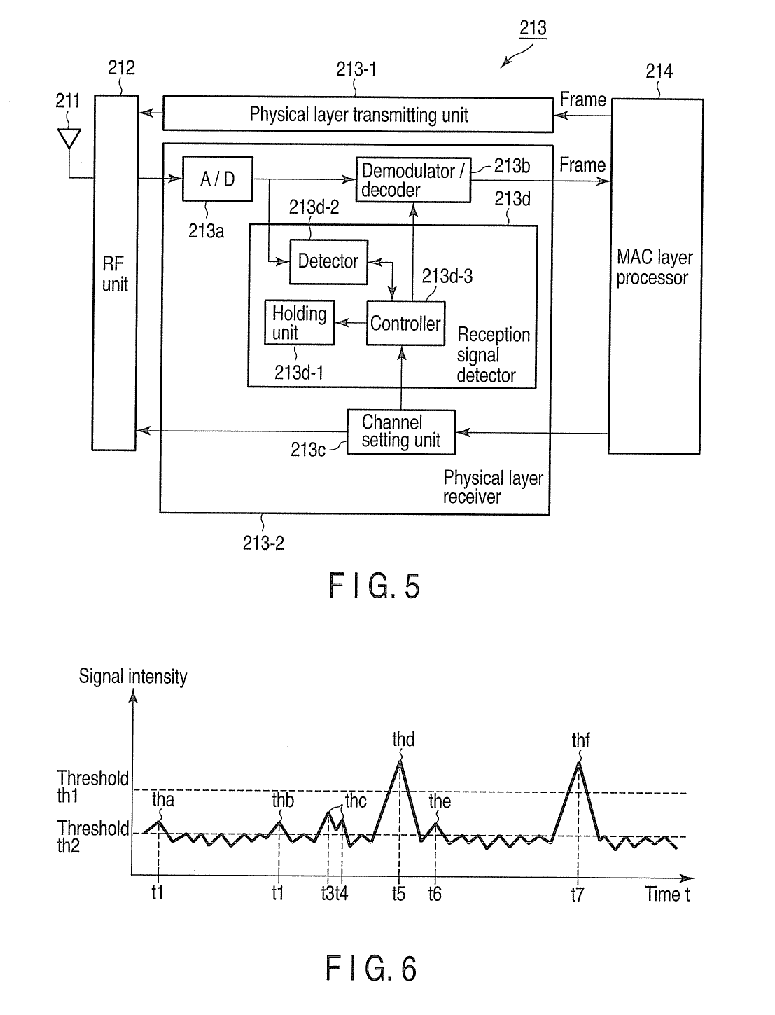

Next, the physical layer processor 213 will be described with reference to FIG. 5. FIG. 5 is a block diagram showing the details of the physical layer processor 213. The physical layer processor 213 includes a physical layer transmitting unit 213-1 and a physical layer receiver 213-2. In the embodiment, paying attention to the physical layer receiver 213-2, the details of the configuration thereof will be described. It is assumed that the physical layer processor 213 according to the embodiment processes a wireless signal using the first communication channel in FIG. 3.

As shown in the diagram, the physical layer receiver 213-2 includes an A/D converter 213a (written as A/D in the diagram), a demodulator/decoder 213b, a channel setting unit 213c, and a reception signal detector 213d. The reception signal detector 213d includes a holding unit 213d-1, a controller 213d-3, and a detector 213d-2. Although the physical layer receiver 213-2 includes a band-limiting filter (analog, digital), it is not shown.

The A/D converter 213a converts a received signal (baseband signal (analog signal) given from the RF unit 212 to a digital signal. The digital signal is output to the demodulator/decoder 213b and the reception signal detector 213d.

The demodulator/decoder 213b demodulates the digital signal supplied from the A/D converter 213a. Specifically, when a signal indicating that a wireless signal is detected is received from the reception signal detector 213d, the digital signal is demodulated from the A/D converter 213a. The demodulator/decoder 213b performs, for example, orthogonal frequency division multiplexing (OFDM) demodulation and error correction decoding on a digital signal exceeding a threshold voltage to generate a reception frame and outputs the reception frame to the MAC layer processor 214.

The channel setting unit 213c receives information of the available frequency bands from the MAC layer processor 214. That is, the channel setting unit 213c receives information of frequency bands in which the wireless LAN base station 100 and the wireless LAN terminal station 200 may perform wireless communication in the frequency bands of 6 GHz or less shown in FIG. 2, that is, a distribution of the first to third frequency bands from the MAC layer processor 214. Specifically, the channel setting unit 213c receives information that the first to third frequency bands are adjacent as shown in FIG. 3A or distributed with predetermined frequency intervals as shown in FIG. 3B. The channel setting unit 213c controls the reception signal detector 213d based on the information of the available frequency bands received from the MAC layer processor 214.

Next, the reception signal detector 213d will be described. As described above, the reception signal detector 213d includes the holding unit 213d-1, the detector 213d-2, and the controller 213d-3. The holding unit 213d-1 holds, for example, a threshold level determining whether a received signal is demodulated or decoded in accordance with the intensity of the received signal. The threshold levels are expressed as thresholds th1 and th2, and it is assumed that the relation of threshold th1>threshold th2 is satisfied.

The detector 213d-2 detects a digital signal supplied from the A/D converter 213a in accordance with the threshold level which is set by the controller 213d-3. FIG. 6 shows a state where the detector 213d-2 detects the digital signal supplied from the A/D converter 213a.

FIG. 6 is a conceptual diagram showing a state where, when a wireless signal received by the wireless LAN terminal station 200 has an intensity exceeding a predetermined threshold level, it is determined that the possibility that the received signal is a wireless LAN signal is high. The vertical axis indicates signal intensity and the horizontal axis indicates time.

In the case where the detector 213d-2 sets the threshold th2 as the threshold level, the detector 213d-2 determines that when a received signal having a signal intensity higher than the threshold th2 is received, the possibility that the signal is a wireless LAN signal is high. On the other hand, as shown in FIG. 6, in time t1 to time t7, the detector 213d-2 determines that the possibility that received signals having signal intensities (levels) tha, thb, thc, thd, the, and thf are wireless LAN signals is high.

On the other hand, in the case where the detector 213d-2 sets the threshold th1 as the threshold level, when a signal having a signal intensity higher than the threshold th1 is received, the detector 213d-2 determines that the possibility that the received signal is a wireless LAN signal is high. That is, the detector 213d-2 determines that the possibility that the received signals having signal intensities thd and thf at times t5 and t7 are wireless LAN signals is high.

The controller 213d-3 receives information of the first to third communication channels from the channel setting unit 213c. The controller 213d-3 refers to the holding unit 213d-2 and selects the threshold th1 or th2 based on the information received from the channel setting unit 213c. Specifically, when it is notified from the channel setting unit 213c that the first to third frequency bands used by the wireless LAN terminal station 200 are adjacent (refer to FIG. 3A), the controller 213d-3 sets the threshold th1 as the threshold level of the detector 213d-2.

On the other hand, when it is notified from the channel setting unit 213c that the first to third frequency bands are apart from one another (refer to FIG. 3B), the controller 213d-3 sets the threshold th2 as the threshold level of the detector 213d-2. When the controller 213d-3 determines that the possibility that the detector 213d-2 has received the wireless LAN signal is high, the controller 213d-3 outputs the result to the demodulator/decoder 213b.

Next, the physical layer transmitting unit 213-1 will be briefly described. The physical layer transmitting unit 213-1 receives a transmission frame and a transmission rate from the MAC layer processor 214. The physical layer transmitting unit 213-1 performs redundant coding and OFDM modulation on the received transmission frame and further performs D/A conversion to obtain an analog signal, and outputs the analog signal as a transmission signal to the RF unit 212. By the physical layer transmitting unit 213-1, the transmission frame is transmitted to the wireless LAN base station 100 via the RF unit 212 and the antenna 211 at a transmission rate determined by the MAC layer processor 214.

Now, referring again to FIG. 4, the MAC layer processor 214 will be described. When a frame is received from the physical layer processor 213, the MAC layer processor 214 eliminates the MAC header from the reception frame and assembles a packet. A packet is transmission/reception data assembled in a data structure which may be handled by a personal computer or the like, and a frame denotes transmission/reception data assembled so that it may be transmitted/received by wireless communication. The MAC header includes, for example, a frame control field. The frame control field bears information necessary for the wireless communication. For example, information such as a direct address or a final address of data, the MAC address of a transmitter, available frequency bands, and bandwidths of the bands is set. The information such as a direct address or a final address of data, the MAC address of a transmitter, available frequency bands, and bandwidths of the bands is transmitted as a beacon frame. The beacon frame is a frame transmitted periodically (for example, at 100 ms intervals) from the wireless LAN base station 100 to the wireless LAN terminal stations 200 and 300. The MAC layer processor 214 receives the beacon frame, reads the address in the beacon frame, and determines whether the received signal is addressed to itself or not. The MAC layer processor 214 receives the beacon frame, and when the beacon frame is a wireless LAN signal addressed to its station, recognizes the available frequency bands and the bandwidths of the wireless LAN signal, and supplies the available frequency bands and its bandwidths to the channel setting unit 213c.

Finally, the MAC controller 240 will be described. Based on the frequency bands used by the first to third communication channels supplied from the MAC layer processors 214, 224, and 234, the MAC controller 240 supplies the information to the physical layer processors 213, 223, and 233. That is, the MAC controller 240 supplies the information indicating whether the first to third communication channels are adjacent or not to the physical layer processors 213, 223, and 233.

<Operation of Wireless LAN Terminal Station 200>

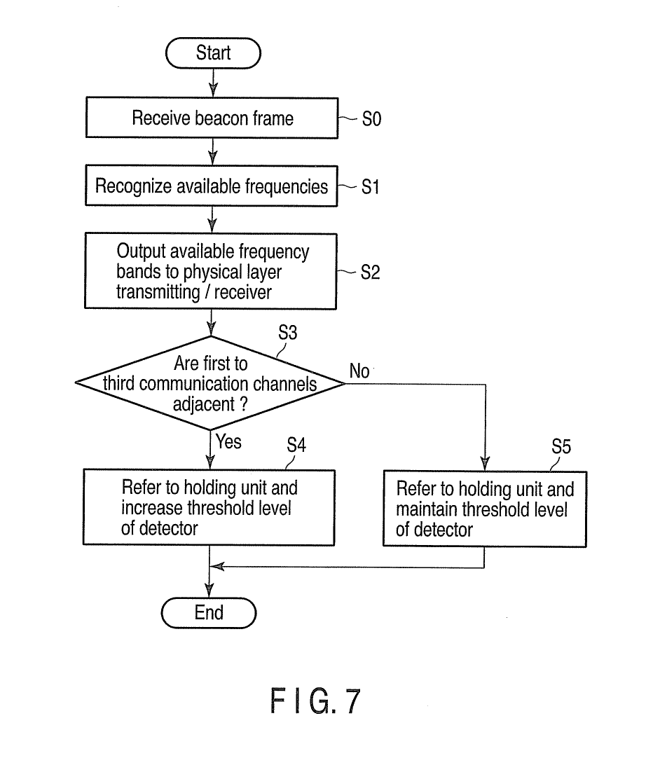

Next, the operation of the wireless LAN terminal station 200 will be described with reference to FIG. 7. In the following, the operation of the wireless LAN terminal station 200 will be described paying attention to the antenna 211, the communication module 210, and the MAC controller 240. Since the operations of the antennas 221 and 231 and the communication modules 220 and 230 are similar to the above, they will not be described.

First, the wireless LAN terminal station 200 receives a wireless signal (beacon frame) by the antenna 211 (step S0). The received wireless signal is down-converted by the RF unit 212 and, after that, the signal is given to the physical layer receiver 213-2. After that, the wireless signal is subjected to pre-determined processing in the physical layer receiver 213-2, and the obtained frame is sent to the MAC layer processor 214. The MAC layer processor 214 recognizes the available frequency bands by referring to the received frame (beacon frame) (step S1).

Next, based on the available frequency bands obtained in step S1, the MAC controller 240 outputs a distribution state of the first to third communication channels (whether they are adjacent or not) to the physical layer receiver 213-2 (channel setting unit 213c) via the MAC layer processor 214 (step S2). In this manner, the channel setting unit 213c outputs the information indicating whether the first to third frequency bands are adjacent or not to the reception signal detector 213d (the controller 213d-3).

In the case where the first to third frequency bands are adjacent (YES in S3), the controller 213d-3 refers to the holding unit 213d-1 and sets (rises) the threshold level to the threshold th1 in the detector 213d-2 (S4).

In the case where the first to third frequency bands are not adjacent, that is, are apart from each other in step S3 (NO in S3), the controller 213d-3 refers to the holding unit 213d-1 and sets the threshold level to the threshold th2 in the detector 213d-2 (S5). In the case where the threshold level is initially set to the threshold th2, if the first to third frequency bands are not adjacent, that is, are apart from each other in step S3 (NO in S3), the controller 213d-3 maintains the threshold level of the detector 213d-2 (S5).

### Effect of First Embodiment

The wireless communication device according to the first embodiment may produce improved communication quality while realizing high-speed communication.

That is, in the wireless communication device according to the first embodiment, the threshold level of detecting a received signal of the detector 213d-2 may be changed according to the distribution states of the first to third frequency bands used. The channel setting unit 213c supplies the distribution of the first to third frequency bands used for the wireless communication, that is, information indicating whether the first to third frequency bands are adjacent or not to the reception signal detector 213d. Even in the case where the first to third frequency bands used are adjacent and the first to third communication channels interfere with each other as shown in FIG. 3A, since the threshold level of the detector 213d-2 is increased, erroneous detection of an interference signal may be prevented and, since the threshold level is decreased, a wireless LAN frame (signal) of low reception level is not missed. In the case where the first to third frequency bands used are apart from each other as shown in FIG. 3B, signals using the first to third communication channels are hardly regarded as interference signals. Consequently, even when the threshold level of the detector 213d-2 is decreased to the threshold th2, erroneous detection of the interference signal may be suppressed, and noise may be reduced. Consequently, even in the case where the wireless LAN terminal station 200 uses the first to third communication channels as shown in FIG. 3A or 3B, by changing the threshold level of the detector 213d-2, the communication quality may be improved while realizing high-speed communication.

### Second Embodiment

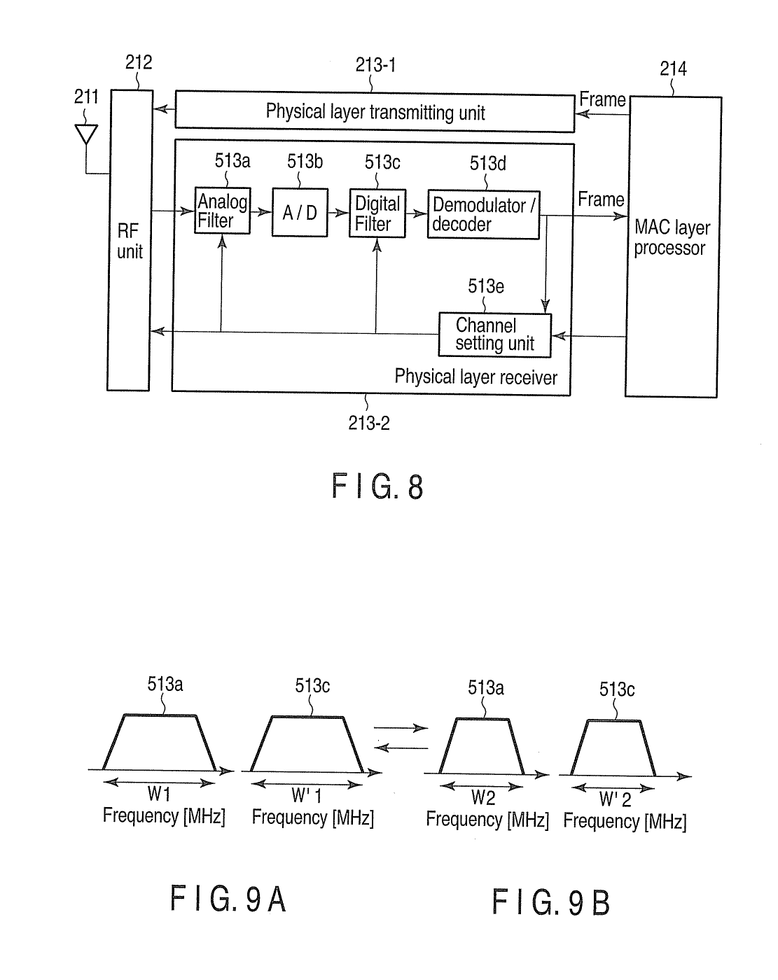

A second embodiment will now be described. In a wireless communication device and a wireless communication method according to the second embodiment, by narrowing the passband of a band limiting filter of the wireless LAN terminal station 200, entry of an interference signal is prevented. For example, when attention is paid to the second communication channel in FIG. 3A, the first and third communication channels become interference signals for the second communication channel. The wireless LAN terminal station 200 according to the embodiment will be described with reference to FIG. 8. FIG. 8 is a block diagram showing the details of the physical layer receiver 213-2 in the wireless LAN terminal station 200 according to the embodiment. Like the first embodiment, it is assumed that the physical layer processor 213 processes a wireless signal using the first communication channel in FIG. 3.

The physical layer receiver 213-2 according to the embodiment includes an A/D converter 513a, a demodulator/decoder 513b, and a channel setting unit 513e in place of the A/D converter 213a, the demodulator/decoder 213b, and the channel setting unit 213c shown in FIG. 5 of the first embodiment and also includes an analog filter 513a and a digital filter 513c while having no reception signal detector 213d. Since the A/D converter 213a and the demodulator/decoder 213b in the first embodiment and the A/D converter 513a and the demodulator/decoder 513d in the second embodiment have the same configuration, respectively, the description will not be repeated.

First, the analog filter 513a will be described. The analog filter 513a filters an analog signal obtained by down-conversion in the RF unit 512. That is, the bandwidth is limited. When the first communication channel has, for example, a bandwidth from (a−40) to a [MHz] as shown in FIG. 3, the analog filter 513a cannot strictly filter the (a−40) to a [MHz] band. That is, signals including a frequency lower than (a−40) MHz and a frequency higher than a MHz are supplied to the A/D converter 513b. That is, in the example of FIG. 3A, a wireless signal using the second communication channel of a to (a+40) MHz becomes an interference signal. Consequently, the (a−40) to a MHz band has to be strictly filtered by the digital filter 513c to be described below.

The digital filter 513c samples the first communication channel of 40 MHz shown in FIG. 3A by the A/D converter 513b and, after that, filters the lower frequency side of (a−40) MHz and the higher frequency side of a MHz. That is, bands on both sides of the first communication channel are discarded.

The channel setting unit 513e controls the analog filters 513a and 513c and the RF unit 512 based on the information of the available frequency bands supplied from the MAC layer processor 540. That is, the channel setting unit 513e receives information that the first to third communication channels are adjacent or distributed (apart) at predetermined frequency intervals from the MAC layer processor 514. In the case where the first to third communication channels are adjacent as shown in FIG. 3A, the channel setting unit 513e controls the analog filter 513a and the digital filter 513c so as to narrow the passband. The value of narrowing the passband is about 0.1 to 3 MHz. On the other hand, in the case where the first to third communication channels are apart from each other as shown in FIG. 3B, the channel setting unit 513e controls the analog filter 513a and the digital filter 513c, for example, so as to maintain the passband through which the first communication channel may pass, not to narrow the passband. FIGS. 9A and 9B show the above-described state.

FIGS. 9A and 9B are conceptual diagrams of the filters through which the analog filter 513a and the digital filter 513c make the wireless signal using the first communication channel pass.

FIG. 9A is a conceptual diagram showing that the passband width of each of the analog filter 513a and the digital filter 513c is maintained, for example, as a width through which a signal each using the first communication channel may pass. As shown in the diagram, the analog filter 513a has a bandwidth of W1, and the digital filter 513c has a bandwidth of W′1. As the bandwidths, the relation W1>W′1, W1<W′1, or W1=W′1 may be satisfied. That is, any filter may be used as long as the band of a wireless signal using the first communication channel may be limited.

FIG. 9B is a conceptual diagram showing that the width of the passband of each of the analog filter 513a and the digital filter 513c is narrowed. As shown in the diagram, the analog filter 513a has a bandwidth of W2, and the digital filter 513c has a bandwidth of W′2. As long as W2 and W′2 are values smaller than W1 and W′1, respectively, any of the relations W2>W′2, W2<W′2, and W2=W′2 may be satisfied. That is, any filter may be used as long as the band of a wireless signal using the first communication channel may be limited.

As shown in the diagram, the analog filter 513a and the digital filter 513c are controlled by the channel setting unit 513e and are switched, as necessary, to any of the filter of FIG. 9A or the filter of FIG. 9B. As a filter switching method, the filters may be switched by a switch or the like. In the case of using a simple filter circuit obtained by combining a resistive element and a capacitor, the values of the resistive element and the capacitor are made variable, and it is sufficient to change the values.

The channel setting unit 513e supplies the frequency band of the first communication channel and the width of the frequency band supplied from the MAC layer processor 214 to the RF unit 211. Consequently, the RF unit 211 may recognize the frequency band and the width of the frequency band and may perform wireless communication with the wireless LAN base station 100.

<Operation of Wireless LAN Terminal Station 200>

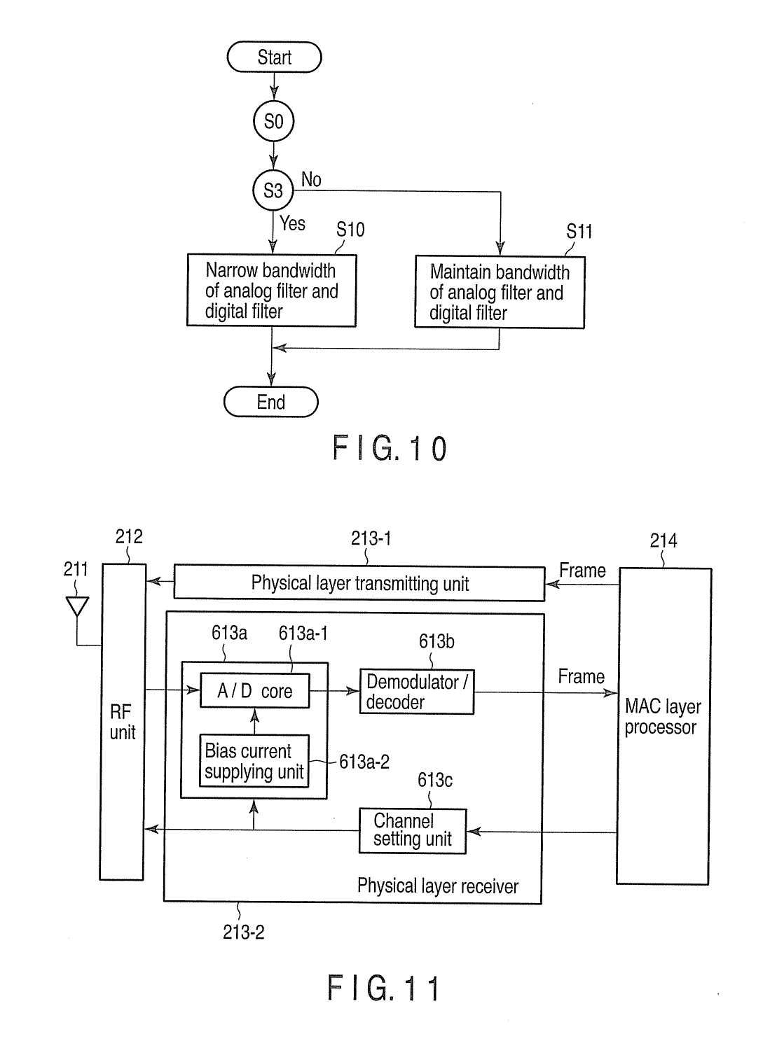

Next, the operation of the wireless LAN terminal station 200 according to the embodiment will be described with reference to FIG. 10. FIG. 10 is a flowchart showing operations of the wireless LAN terminal station 200. First, the wireless LAN terminal station 200 executes processes from step S0 to S3 shown in FIG. 7. The wireless LAN terminal station 200 establishes a connection so that wireless communication may be performed with the wireless LAN base station 100 in the BSS, and after that, receives the beacon frame from the wireless LAN base station 100 (S0) and recognizes distributions of the first to third communication channels (S1). In the case where the first to third communication channels are adjacent in step S3 (YES in S3), the channel setting unit 513e controls the analog filter 513a and the digital filter 513c to narrow the passband width (S10). In the case where the first to third communication channels are apart in step S3 (NO in S3), the channel setting unit 513e controls the analog filter 513a and the digital filter 513c so that a signal may pass through, for example, the first communication channel, not to narrow the passband width (S11).

In the case where the first to third communication channels are adjacent in step S3 (YES in S3), the channel setting unit 513e may control the analog filter 513a and the digital filter 513c to maintain the passband width, not to narrow the passband width. That is, when the band widths of the analog filter 513a and the digital filter 513c are W2 and W′2, respectively, even in the case where the first to third communication channels are adjacent to each other (YES in S3), the band width is maintained.

In the case where the first to third communication channels are apart in step S3 (NO in S3), the channel setting unit 513e may control the analog filter 513a and the digital filter 513c to widen the passband width from W2 and W′2 to W1 and W′1, respectively.

### Effect of Second Embodiment

The wireless communication device according to the second embodiment may produce improved communication quality while realizing high-speed communication.

In the wireless communication device according to the second embodiment, the channel setting unit 513e controls the analog filter 513a and the digital filter 513c in accordance with information of the first to third communication channels supplied from the MAC layer processor 214. In the case where the first to third communication channels are adjacent and it is feared that signals using the first to third communication channels become interference signals, by narrowing the passband of each of the analog filter 513a and the digital filter 513c, entry of an interference signal may be prevented. For example, when the antenna 521 receives a second communication channel as a desired signal, wireless signals using the first and third communication channels may be prevented from entering, as interference signals, a wireless signal using the second communication channel. In such a manner, the communication quality may be improved. In the case where the first to third communication channels are apart as shown in FIG. 3B, signals using the communication channels hardly enter as interference signals, so that deterioration in a received signal may be suppressed without narrowing the bandwidth of each of the analog filter 513a and the digital filter 513c. In such a manner, the communication quality may be improved.

### Third Embodiment

Next, a wireless communication device and a wireless communication method according to a third embodiment will be described. In the wireless communication device and the wireless communication method according to the embodiment, at the time of converting an analog signal received by an RF unit to a digital signal, the number of valid bits is set according to distributions of the first to third communication channels. The wireless LAN terminal station 200 according to the embodiment will be described with reference to FIG. 11.

FIG. 11 is a block diagram showing the details of the physical layer receiver 213-2 in the wireless LAN terminal station 200 according to the embodiment. Like the first embodiment, it is assumed that the physical layer processor 213-2 processes a wireless signal using the first communication channel in FIG. 3.

The physical layer receiver 213-2 according to the embodiment is different from that in FIG. 5 of the first embodiment in the following points. A demodulator/decoder 613b and a channel setting unit 613c are provided in place of the demodulator/decoder 213b and the channel setting unit 213c, further, the A/D converter 213a and the reception signal detector 213d are not provided, and an A/D converter 613a is provided. The A/D converter 613a according to the third embodiment is provided in place of the A/D converter according to the first and second embodiments and may set the number of valid bits. Since the demodulator/decoder 513b has the same configuration as that of the demodulator/decoder 213b, the description will not be repeated.

First, the A/D converter 613a will be described. The A/D converter 613a includes an A/D core 613a-1 and a bias current supplying unit 613a-2. The A/D core 613a-1 converts an analog signal received by an antenna 211 and down-converted by an RF unit 612 to a digital signal in accordance with a current value supplied from the bias current supplying unit 613a-2. The bias current supplying unit 613a-2 supplies the current value according to the distribution state of the first to third communication channels supplied from the channel setting unit 613c to the A/D core 613a-1. Currents output from the bias current supplying unit 613a-2 are expressed as currents I₁ and I₂. It is assumed that the relation of current I₂>current I₁ is satisfied. Specifically, when it is notified from the channel setting unit 613c that the first to third communication channels are adjacent each other as shown in FIG. 3A, the bias current supplying unit 613a-2 outputs the current I₂ to the A/D core 613a-1. By such operation, the number of valid bits when the A/D core 613a-1 performs the A/D conversion increases. That is, even in the case where noise enters a wireless signal using the first communication channel by interference signals (in the second and third communication channels) adjacent to the first communication channel, A/D conversion may be finely executed on the wireless signal.

When it is notified from the channel setting unit 613c that the first to third communication channels are apart as shown in FIG. 3B, the bias current supplying unit 613a-2 supplies the current I₁ to the A/D core 613a-1. That is, the number of valid bits of the A/D core 613a-1 decreases as compared with the above case. However, if the first to third communication channels are apart, the possibility that signals using the first to third communication channels become interference signals is low. Consequently, even in a state where the number of valid bits of the A/D core 613a-1 is small, the error probability in the demodulator/decoder 613b at a post stage may be suppressed to be low.

<Operation of Wireless LAN Terminal Station 200>

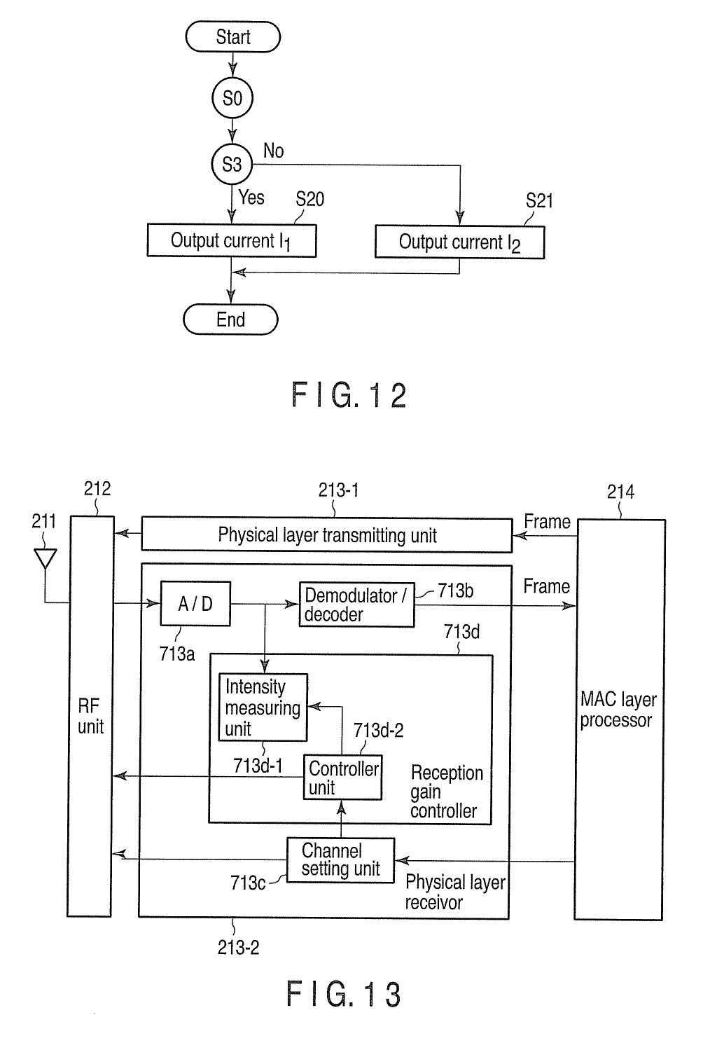

Next, the operation of the wireless LAN terminal station 200 will be described with reference to FIG. 12. FIG. 12 is a flowchart showing operations of the wireless LAN terminal station 200. First, the wireless LAN terminal station 200 executes processes from step S0 to S3 described in the first embodiment. In the case where the first to third communication channels are adjacent in step S3 (YES in S3), the bias current supplying unit 613a-2 outputs the current I₁ to the A/D core 613a-2 (S20). The A/D core 613a-2 converts the analog signal supplied from the RF unit 612 to a digital signal with a large number of valid bits.

In the case where the first to third communication channels are apart from one another in step S3 (NO in S3), the bias current supplying unit 613a-2 outputs the current I₂ to the A/D core 613a-2 (S21). The A/D core 613a-2 converts the analog signal supplied from the RF unit 612 to a digital signal with the number of valid bits smaller than that in step S20.

### Effect of Third Embodiment

The wireless communication device and the wireless communication method according to the third embodiment may produce improved communication quality while realizing high-speed communication.

In the wireless communication device and the wireless communication method according to the third embodiment, the channel setting unit 613c controls the A/D converter 613a in accordance with information of the first to third communication channels supplied from the MAC layer processor 614. In the case where the first to third communication channels are adjacent and there is the possibility that an interference signal enters, the channel setting unit 613c controls the bias current supplying unit 613a-2 to set the current value to I₁. In this manner, even in the case where an interference signal enters and a desired waveform is deformed, by setting the number of valid bits of the A/D converter 613a high, the A/D conversion may be finely executed on the received signal and the original signal waveform may be reproduced.

Further, the wireless communication device according to the third embodiment may suppress power consumption, in addition to the above effect. In the case where the distributions of the first to third communication channels are apart as shown in FIG. 3B, the possibility that an interference signal enters is low. Consequently, for example, using the first communication channel, a low-skew wireless signal is transmitted from the wireless LAN base station 100. Consequently, the bias current supplying unit 613a-2 outputs the current I₂ to the A/D core 613a-1. That is, even in the case where the number of valid bits of the A/D core 613a-1 is smaller and the A/D conversion is performed coarsely on the received signal, since the received signal has a skew smaller than the above, the original signal waveform may be reproduced while suppressing power consumption.

### Fourth Embodiment

Next, a wireless communication device and a wireless communication method according to a fourth embodiment will be described. In the wireless communication device and the wireless communication method according to the embodiment, the gain of an input level of a received signal which is input to an A/D converter is changed according to distributions of the first to third embodiments.

The wireless LAN terminal station 200 according to the embodiment will be described with reference to FIG. 13. FIG. 13 is a block diagram showing the details of the physical layer receiver 213-2 in the wireless LAN terminal station 200 according to the embodiment. It is assumed that the physical layer processor 213-2 processes a wireless signal using the first communication channel in FIG. 3.

As shown in the diagram, the physical layer receiver 213-2 according to the embodiment includes an A/D converter 713a, a demodulator/decoder 713b, and a channel setting unit 713c in place of the A/D converter 213a, the demodulator/decoder 213b, and the channel setting unit 213c shown in FIG. 5 of the first embodiment. Further, the reception signal detector 213d is not provided but a reception gain controller 713d is provided. Since the function of the demodulator/decoder 213b and that of the demodulator/decoder 713d are the same, the description will not be repeated.

First, the A/D converter 713a will be described. The A/D converter 713a supplies a digital signal component to the demodulator/decoder 713b and the reception gain controller 713d.

The reception gain controller 713d includes an intensity measuring unit 713d-1 and a controller 713d-2. The intensity measuring unit 713d-1 measures the voltage value of the digital signal supplied from the A/D converter 713a.

The controller 713d-2 refers to the intensity of the voltage measured by the intensity measuring unit 713d-1. The controller 713d-2 controls the reception gain of the RF unit 212 so as to match the input level of the received signal with a target value which is set in the RF unit 212 by the channel setting unit 713c which will be described later. Specifically, the controller 713d-2 refers to the signal intensity and, when the input level of the received signal received by the RF unit 212 is higher than the target value supplied from the channel setting unit 713c, decreases the input level of the received signal so as to match the target value which is set by the channel setting unit 713c.

On the other hand, the controller 713d-2 refers to the signal intensity and, when the input level of the received signal received by the RF unit 212 is lower than the target value supplied from the channel setting unit 713c, increases the input level of the received signal so as to match the target value which is set by the channel setting unit 713c. In such a manner, the controller 713d-2 controls the gain of the input level of the received signal. By such control, the input level of a signal received by the RF unit 212 is made constant.

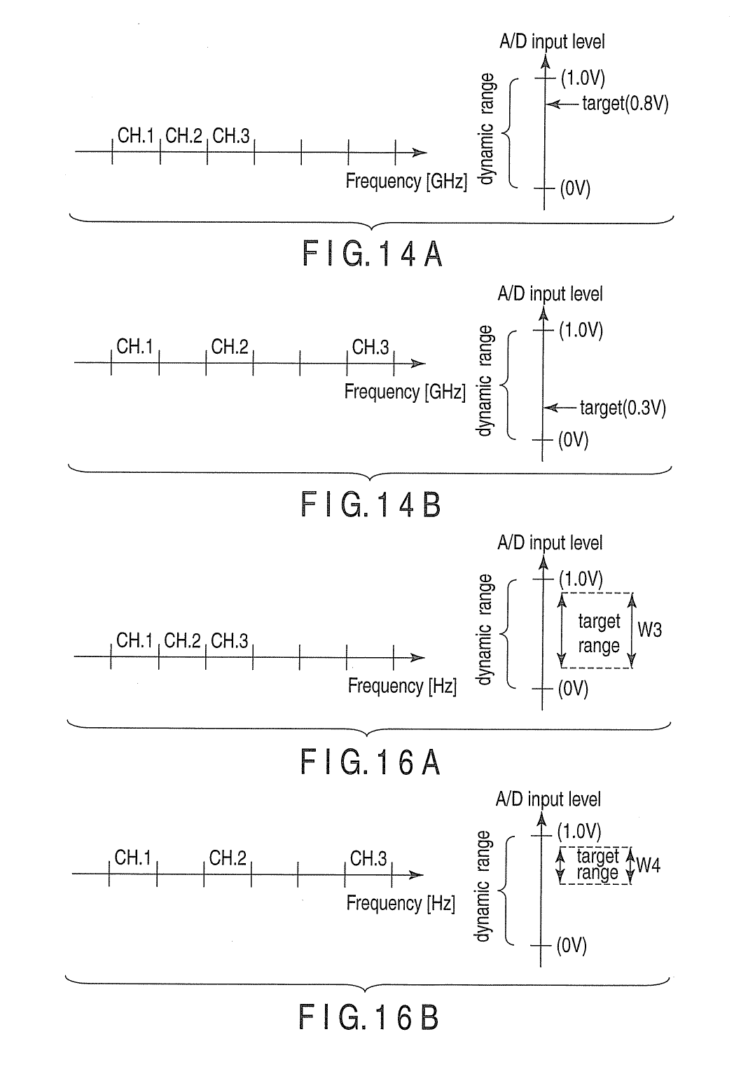

The channel setting unit 713c sets the target value (written as “target” in FIG. 14) of the input level of a signal received by the RF unit 212 in accordance with information indicating whether the first to third communication channels are adjacent or not from the MAC layer processor 214 and supplies the target value to the RF unit 212 and the controller 713d-2.

For example, when the information that the first to third communication channels are adjacent is received from the MAC layer processor 214, the channel setting unit 713c sets so as to increase the target value of the input level of a signal received by the RF unit 212. Specifically, in the case as shown in FIG. 3A, there is the possibility that the interference signals (the wireless signals using the second and third communication channels) enter the received signal (first communication channel), and the amplitude of a desired signal to be received is amplified by the interference. In this case, by increasing the amplitude of a received desired signal (baseband signal), the signal intensity of a component of a desired received signal may be sufficiently obtained. Consequently, the channel setting unit 713c increases the target value of the input level of the signal to be received.

On the other hand, when the information that the first to third communication channels are apart is received from the MAC layer processor 214, the channel setting unit 713c sets so as to decrease the target value of the input level of a signal received by the RF unit 212. Specifically, in the case as shown in FIG. 3B, contamination of the interference signals in the received signal (first communication channel in this case) is little, so that distortion of a desired signal to be received is small. Consequently, the channel setting unit 713c sets the target value of the input level of a signal received by the RF unit 212 to be lower than that in the above description.

FIGS. 14A and 14B show this state. FIGS. 14A and 14B are conceptual diagrams showing the input level of a received signal according to the distribution state of the first to third communication channels. In FIGS. 14A and 14B, the first, second, and third communication channels are expressed as CH.1, CH.2, and CH.3, respectively.

FIG. 14A is a conceptual diagram showing the case where frequency bands used by the first to third communication channels shown in FIG. 3A are adjacent to each other, and the channel setting unit 713c sets the input level of a signal received by the RF unit 212.

As shown in the conceptual diagram, the level received by the RF unit 212 and, after that, input to the A/D converter 713a is set to, for example, 0.8 V with respect to the range width of 1.0 V.

FIG. 14B is a conceptual diagram showing the case where frequency bands used by the first to third communication channels shown in FIG. 3B are apart from each other, and the channel setting unit 713c sets the input level of a signal received by the RF unit 212. As shown in FIG. 14B, the level received by the RF unit 212 and, after that, input to the A/D converter 713a is set to, for example, 0.3 V with respect to the range width of 1.0 V.

<Operation of Wireless LAN Terminal Station 200>

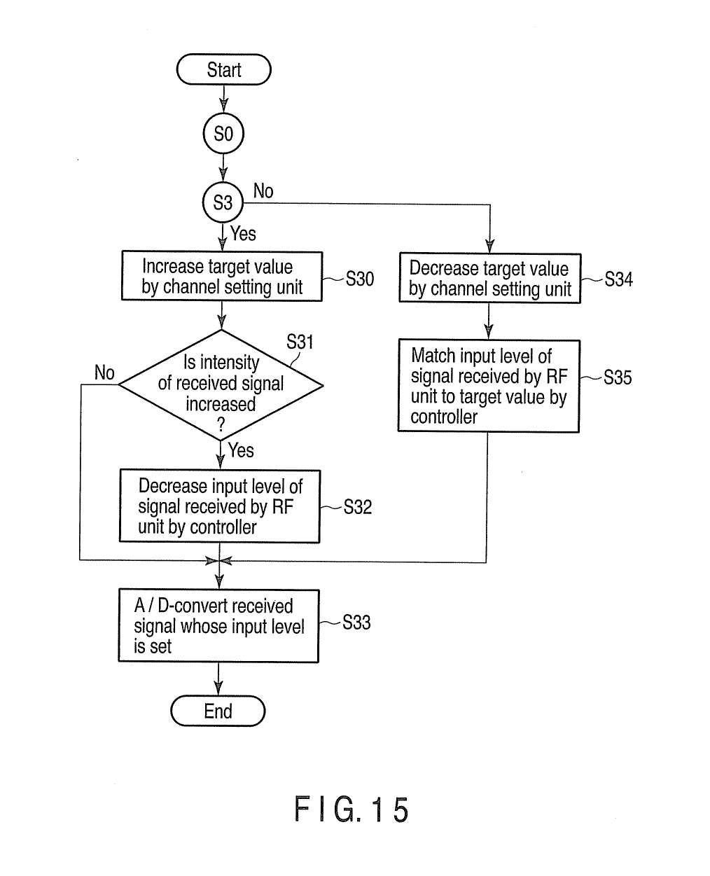

Next, the operation of the wireless LAN terminal station 200 having the above configuration will be described with reference to FIG. 15. FIG. 15 is a flowchart showing operations of the wireless LAN terminal station 200. First, the wireless LAN terminal station 200 executes processes from step S0 to S3 in a manner similar to the first embodiment. The wireless LAN terminal station 200 establishes connection so that wireless communication may be performed with the wireless LAN base station 100 in the BSS, and after that, receives the beacon frame from the wireless LAN base station 100, and recognizes distributions of the first to third communication channels.

In the case where the first to third communication channels are adjacent in step S3 (YES in S3), the channel setting unit 713c sets so as to increase the target value of the input level of a signal received by the RF unit 212 (S30). In such a manner, the input level of a wireless signal received by the RF unit 212 is set.

The controller 713d-2 refers to the signal intensity measured by the intensity measuring unit 713d-1 and, when the signal intensity is higher than the target value supplied from the channel setting unit 713c (YES in S31), decreases the input level of the received signal so as to match the target value which is set by the channel setting unit 713c (S32). After that, the A/D converter 713a converts the received signal whose input level is set to a digital signal (S33). The controller 713d-2 refers to the signal intensity and, when the input level of the received signal is about a target value (NO in S31), maintains the intensity of the received signal, and performs the process in step S33.

In the case where the first to third communication channels are apart in step S3 (NO in S3), the channel setting unit 713c sets so as to decrease the target value of the input level of a signal received by the RF unit 212 (S34). In such a manner, the input level of a wireless signal received by the RF unit 212 is set.

The controller 713d-2 refers to the signal intensity measured by the intensity measuring unit 713d-1 and matches the signal intensity with the target value supplied from the channel setting unit 713c (S35). Specifically, when the input level of a received signal referred to decreases and becomes about the target value, the controller 713d-2 maintains the intensity of the received signal, and performs the process in step S33 at the input level.

On the other hand, when the input level of a received signal is lower than the target value, the controller 713d-2 increases the input level of the received signal to the target value, and performs the process in step S33. When the input level of a received signal is higher than the target value, the controller 713d-2 decreases the input level of the received signal to the target value, and performs the process in step S33.

### Effect of Fourth Embodiment

The wireless communication device and the wireless communication method according to the fourth embodiment may produce improved communication quality while realizing high-speed communication.

In the wireless communication device and the wireless communication method according to the fourth embodiment, the channel setting unit 713c sets a target value of the input level of a received signal in the reception gain controller 713d and the RF unit 212 in accordance with whether frequency bands used by the first to third communication channels are adjacent to each other or not, and the controller 713d-2 controls the RF unit 212 so that the input level of the received signal becomes close to the target value.

When the first to third communication channels are distributed so as to be apart from each other and the signal intensity of a received signal is about the target value set by the channel setting unit 713c, the signal intensity is maintained. That is, the gain of the received signal is maintained. When the signal intensity of the received signal is lower than the target value which is set by the channel setting unit 713c, the signal intensity is increased, and the input level is matched with the target value.

When the frequency bands used by the first to third communication channels are distributed so as to be adjacent and the signal intensity of a signal to be received (for example, the first communication channel) is higher than the target value, the controller 713d-2 decreases the signal intensity of a wireless signal received by the RF unit 212.

That is, the controller 713d-2 does not control the input level of a signal received by the RF unit 212 in accordance with the input level measured by the intensity measuring unit but may set the input level of the received signal based on whether the first to third communication channels are adjacent or not. In other words, based solely on the information of whether the frequency bands used by the first to third communication channels are adjacent to each other or not, the proper input level of a signal received by the RF unit 212 may be set. That is, the communication quality may be improved.

When the signal intensity of a received wireless signal has a predetermined amplitude, the reception gain controller 713d may fix the value of the gain of the wireless signal, i.e., stop it fluctuating. FIGS. 16A and 16B show this state. FIGS. 16A and 16B are conceptual diagrams showing a permissible range of fixing the reception gain with respect to a fluctuation range of the input level of a received signal which changes according to a distribution state of the first to third communication channels. The controller 713d-2 sets the permissible range of fixing the gain of a wireless signal in accordance with the distribution state of the first to third communication channels.

In the case where the first to third communication channels are adjacent to each other as shown in FIG. 16A, a wireless signal received by the antenna 211 and then supplied to the RF unit 212 is contaminated with an interference signal (noise), so that the amplitude of a signal transmitted from the wireless LAN base station 100 tends to increase. That is, the antenna 211 receives a signal having a large amplitude (voltage difference).

In contrast, as shown in FIG. 16A, a range width W3 is set to be larger than a range width W4 in FIG. 16B. In the case of receiving a wireless signal in the range width (W3), the controller 713d-2 fixes the gain. In such a manner, smooth demodulation/decoding may be realized. In the case where the intensity of a received signal is out of the range width W3 shown in FIG. 16A, the controller 713d-2 changes the gain of a wireless signal received by the controller 713d-2. Specifically, when the intensity of the received signal is out of the range width W3 and shifted to the 1.0 V side, the gain of the received signal is increased. When the intensity is shifted to the 0 V side, the signal intensity of the received signal is decreased.

On the other hand, in the case where the first to third communication channels are apart from each other as shown in FIG. 16B, a wireless signal received by the antenna 211 and then supplied to the RF unit 212 is less contaminated with an interference signal (noise) than the case of FIG. 16A. Consequently, the amplitude of the signal sent from the wireless LAN base station 100 tends to be constant without being distorted. That is, the antenna 211 receives a signal having a small amplitude (voltage difference). As shown in FIG. 16B, in the case of receiving a signal in the range width (W4) smaller than the range width W3 in FIG. 16A, the controller 713d-2 fixes the gain of a received signal. In the case where the intensity of a received signal is out of the range width W4 shown in FIG. 16B, the controller 713d-2 changes the gain of a wireless signal received. Specifically, when the intensity of the received signal is out of the range width W4 and shifted to the 1.0 V side, the gain of the received signal is increased. When the intensity is shifted to the 0 V side, the signal intensity of the received signal is decreased. In such a manner, smooth demodulation/decoding may be realized.

Although the case where the first to third communication channels are adjacent to each other has been described in the first to fourth embodiments, for example, the effect may be produced also in the case where only the first and second communication channels are adjacent to each other. In this case, since the antennas 211 and 221 receive wireless signals using the first and second communication channels adjacent to each other, the wireless signal using the second communication channel is an interference signal for the antenna 211, and a wireless signal using the first communication channel is an interference signal for the antenna 221. By executing the operations in the case of the channels being adjacent described in the first to fourth embodiments on the communication modules 210 and 220, the effects (1) to (5) may be produced.

Even in the case where the first to third communication channels are apart from one another, when wireless signals used by other wireless communication system are distributed so as to be adjacent to each of the first to third communication channels or so as to sandwich the first to third communication channels, operations similar to those in the case where the first to third communication channels are adjacent to each other may be performed. In this case, it is only necessary to include information of a communication channel used by another wireless communication system in a received beacon frame.

Although the physical layer processor 213 has been described in the first to fourth embodiments, the physical layer processor 213 obtained by combining those configurations may be also employed. Specifically, the physical layer processor 213 may simultaneously include the reception signal detector 213d, the analog filter 513a, the digital filter 513c, the A/D converter 613a, and the reception gain controller 713d.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication device comprising:
a receiver which receives wireless signals by using a plurality of communication channels as a baseband signal;
a physical layer processor which processes a physical layer of the baseband signal received by the receiver;
a MAC layer controller which recognizes a first frequency band used by a first communication channel in the communication channels, based on the baseband signal supplied from the physical layer processor, and determines whether a second frequency band used by a second communication channel different from the first communication channel in the communication channels is adjacent to the first frequency band or not; and
a channel setting unit which supplies the first frequency band supplied from the MAC layer controller and used by the first communication channel to the receiver, and controls the physical layer processor depending on information as to whether the first frequency band supplied from the MAC layer controller is adjacent to the second frequency band or not.

2. The device according to claim 1, wherein the physical layer processor executes a predetermined process on the baseband signal being used in the first communication channel by the receiver so as to prevent the baseband signal from being influenced by an interference signal depending on the information supplied from the channel setting unit.

3. The device according to claim 2, wherein the physical layer processor comprises:
an A/D converter which Analog to Digital converts the baseband signal received by the receiver;
a demodulator/decoder which demodulates/decodes a digital signal obtained by the A/D conversion of the A/D converter; and
a signal detector which detects the digital signal supplied from the A/D converter depending on the information from the channel setting unit, and
the signal detector comprises:
a detector which detects the digital signal supplied from the A/D converter;
a holding unit which holds a threshold level for detecting the digital signal; and
a controller which, when the information is received from the channel setting unit, refers to the holding unit, changes a threshold level of the detector based on the information, and when the detector detects the baseband signal received by the receiver, supplies the result of detecting the baseband signal to the demodulator/decoder.

4. The device according to claim 3, wherein in case that the first and second frequency bands are apart from each other, the controller sets the threshold level to a first level, and
in case that the first and second frequency bands are adjacent to each other, the controller sets the threshold level to a second level higher than the first level.

5. The device according to claim 2, wherein the physical layer processor comprises:
a first filter which limits the first frequency band used by the first communication channel;
an A/D converter which performs analog/digital conversion on the baseband signal received by the receiver, a band of the baseband signal being limited by the first filter;
a second filter which limits the first frequency band in the baseband signal which is digitally converted by the A/D converter; and
a demodulator/decoder which demodulates/decodes the baseband signal whose band is limited by the second filter, and
the channel setting unit
sets a bandwidth of each of the first filter and the second filter through which the baseband signal passes to W1 in the case where the first frequency band is apart from the second frequency band, based on the information, and
sets a bandwidth of the first filter and the second filter through which the baseband signal received by the receiver passes to W2 narrower than the bandwidth W1 in the case where the first frequency band is adjacent to the second frequency band.

6. The device according to claim 5, wherein the W1 includes w1′ and w1″, the w1′ denotes a width of the first filter, w1″ denotes a width of the second filter, the widths w1′ and w1″ satisfy any of relations of w1′>w1″, w1′<w1″, and w1′=w1″, and
the width W2 includes w2′ and w2″, the w2′ denotes the width of the first filter, the w2″ denotes the width of the second filter, and the widths w2′ and w2″ satisfy any of relations of w2′>w2″, w2′<w2″, and w2′=w2″.

7. The device according to claim 4, wherein switching between the width W1 and the width W2 by the channel setting unit is performed by changing values of a resistive element and a capacitor in each of the first filter and the second filter or by switching using a switch circuit.

8. The device according to claim 2, wherein the physical layer processor comprises:
an A/D converter which digitally converts the baseband signal received by the receiver;
a supply unit which adjusts a current value output to the A/D converter, based on the information supplied from the channel setting unit; and
a demodulator/decoder which demodulates/decodes the baseband signal digitally converted by the A/D converter,
in the case where the first frequency band is adjacent to the second frequency band, the supply unit sets the current value to I₁ and increases the number of valid bits in the A/D converter, and
in the case where the first frequency band is apart from the second frequency band, the supply unit sets the current value to I₂ smaller than the I₁ and decreases the number of valid bits in the A/D converter.

9. The device according to claim 2, wherein the physical layer processor comprises:
an A/D converter which digitally converts the baseband signal received by the receiver;
a demodulator/decoder which demodulates/decodes the baseband signal digitally converted by the A/D converter; and
a gain controller which adjusts an input level of the baseband signal which is input to the receiver, based on the information supplied from the channel setting unit and the baseband signal digitally converted by the A/D converter,
the gain controller comprises:
a measuring unit which measures a magnitude of a voltage of the baseband signal; and
a controller which, in case that a measurement result of the measuring unit is larger than a target value, decreases a gain such that the measurement result becomes close to the target value and, in case that the measurement result is smaller than the target value, increases the gain such that the measurement result becomes close to the target value, and
the channel setting unit holds, as the target values, a first target value for setting an input level of the baseband signal which is input to the receiver based on the information and a second target value larger than the first target value, and
the channel setting unit
sets the second target value as the target value in the case where the first frequency band is adjacent to the second frequency band and,
sets the first target value as the target value in the case where the first frequency band is apart from the second frequency band.

10. The device according to claim 2, wherein the physical layer processor comprises:
an A/D converter which digitally converts the baseband signal received by the receiver;
a demodulator/decoder which demodulates/decodes the baseband signal; and
a gain controller which, based on upper and lower limit values of a fluctuating voltage of the baseband signal supplied from the A/D converter, fixes or fluctuates an input level of the baseband signal received by the receiver, and based on the information supplied from the channel setting unit, fluctuates a range width of the voltage as an index of fixing or fluctuating the input level of the baseband signal received by the receiver, and
the gain controller comprises:
a measuring unit which measures a magnitude of the voltage and fluctuation of the value of the voltage; and
a controller which refers to the range width,
in the case where the upper and lower limit values of the fluctuating value of the voltage measured by the measuring unit fall in the range width, causes the receiver to receive the baseband signal which is input to the receiver at the input level and,
in the case where any of the upper and lower limit values of the fluctuating value of the voltage is out of the range width, causes the receiver to receive the baseband signal whose input level is fluctuated.

11. The device according to claim 10, wherein when the first and second frequency bands are adjacent to each other, the gain controller sets the range width to W3, and
when the first and second frequency bands are apart from each other, the gain controller sets the range width to W4 narrower than the width W3.

12. The device according to claim 2, wherein frequency bands usable by the first and second communication channels are 6 GHz or less.

13. A wireless communication method comprising:
receiving a wireless signal using a plurality of communication channels and down-converting the wireless signal to a baseband signal;
processing a physical layer in the baseband signal;
based on the processed baseband signal, recognizing a first frequency band used by a first communication channel, and determining whether a second frequency band used by a second communication channel different from the first communication channel in the communication channels is adjacent to the first frequency band; and
according to information as to whether the first frequency band is adjacent to the second frequency band or not, executing a predetermined process on the baseband signal so as to prevent the baseband signal received from being influenced by an interference signal.

14. The method according to claim 13, wherein the predetermined process comprises:
obtaining a digital signal by performing analog/digital conversion on the baseband signal;
changing a level of detecting the digital signal in accordance with the information; and
when reception of the digital signal is detected, demodulating/decoding the detected digital signal.

15. The method according to claim 13, wherein when the first frequency band is adjacent to the second frequency band, the level is increased, and
when the first and second frequency bands are apart from each other, the level is decreased.

16. The method according to claim 13, wherein the predetermined process comprises:
in case that the first frequency band and the second frequency band are apart from each other, filtering a first frequency band used by the first communication channel by using first and second filters each having a bandwidth W1, the first filter being an analog filter, the second filter being a digital filter; and
in case that the first frequency band and the second frequency band are adjacent to each other, filtering the first frequency band used by the first communication channel by using the first and second filters each having a bandwidth W2, the bandwidth W2 being narrower than the bandwidth W1.

17. The method according to claim 13, wherein the predetermined process comprises:
obtaining a digital signal by performing analog/digital conversion on the baseband signal;
in case that the first frequency channel is apart from the second frequency channel, decreasing the number of valid bits at the time of performing the analog/digital conversion on the received baseband signal; and
in case that the first frequency channel is adjacent to the second frequency channel, increasing the number of valid bits at the time of performing the analog/digital conversion on the received baseband signal.

18. The method according to claim 13, wherein the predetermined process comprises:
setting an input level of the wireless signal received to a target value, based on the information;
referring to an intensity of the baseband signal subjected to the analog/digital conversion; and
making the input level close to the target value by increasing the input level in case that the input level is lower than the target value or by decreasing the input level in case that the input level is higher than the target value.

19. The method according to claim 13, wherein the predetermined process comprises:
trimming a range width of a voltage as an index of permitting fixing of the input level of the baseband signal, based on the information; and
fixing or fluctuating the input level of the baseband signal, based on a relativity between upper and lower limit values of a fluctuating voltage of the baseband signal and the range width.

20. The method according to claim 19, further comprising:
referring to the range width, and in the case where the upper and lower limit values of the fluctuating value of the voltage fall in the range width, fixing the input level of the baseband signal received; and
referring to the range width, and in the case where any of the upper and lower limit values of the fluctuating value of the voltage is out of the range width, fluctuating the input level of the baseband signal received.
